(19) United States
(12) Patent Application Publication
(10) Pub. No.: US 2005/0044072 A1
(43) Pub. Date: Feb. 24, 2005

(54) Methods and systems for selecting travel products

(76) Inventor: Robert J. Maier, Mt. Laurel, NJ (US)

Correspondence Address: WHITE & CASE LLP;PATENT DEPARTMENT, 1155 AVENUE OF THE AMERICAS, NEW YORK, NY, 10036, US

(21) Appl. No.: 10/916,042

(22) Filed: Aug. 10, 2004

Related U.S. Application Data
(63) Continuation of application No. 09/731,463, filed on Dec. 7, 2000, now abandoned.
(60) Provisional application No. 60/226,442, filed on Dec. 7, 1999.

(51) Int. Cl. G06F 17/30

(52) U.S. Cl. 707/3

(57) ABSTRACT

A system for selecting travel products is described. The methods and system of the invention enable a travel agent or client to search a travel database that contains information about: (i) technical specifications about a travel product; (ii) price information for the travel product; (iii) comparative pricing information about the travel product, e.g., travel specials; (iv) graphical and pictorial information about the travel product; (v) sales and promotional messages; (vi) a uniform resource locator (URL) address for a Web site containing information and hyperlinks to other Internet sites of interest on the Worldwide Web; or (vii) on virtual faxes. The methods and system of the present invention enable the travel agent to search a remotely located travel database using a wide range of selection criteria and provide the supplier of travel products with a comparatively inexpensive and rapid method for distributing information about all their travel products using a system of virtual faxes. The methods and systems of searching, retrieving and distributing information using this invention may be applied to other areas requiring rapid distribution of information to a geographically disperse group of users.

This application claims the benefit of U.S. Provisional No. 60/226,442 filed Dec. 7, 1999.

### BACKGROUND OF THE INVENTION

The present invention relates to improved information retrieval methods and systems. In particular, the invention relates to improved information-retrieval methods and systems for travel products that utilize the Internet.

Suppliers of travel products, e.g., package vacations, airplane flights, and hotels, have developed a distribution system used by travel agents to help travelers (hereinafter, travelers are referred to as clients) select a particular travel product. Information is delivered to the travel agent in several different ways. Travel agents often use travel brochures to select a particular travel product. Typically, travel brochures provide general information about the type of vacation as well as specific information regarding various other products offered by the travel supplier, e.g., special discount travel packages. In order to make an informed decision, both the travel agents and their clients read the travel brochures about where to go on vacation. Given that the entire world is now accessible to travel, it is not possible for any one travel agent to know the details about more than a limited number of different travel products. At best, the travel agent can offer the client information about a few vacations.

Not only is the travel agent limited in the range of travel products they know, but also the supplier of travel products cannot afford to supply information about all possible travel products using the current information distribution channels. The costs of producing and distributing travel brochures is comparatively high. For example, a typical travel brochure costs as much as two to three dollars to publish. Travel brochures are often sent to the travel agent by overnight mail further adding to the costs of production. It is also well known in the travel industry that travel agents do not read or even use the travel brochures that they receive. First, the travel agent receives too many travel brochures to display in their office (a typical display rack in the travel agency holds only 10-14 travel brochures). Second, even if the travel brochure is read by the travel agent it is frequently out-of-date by the time that the travel agent can display the travel brochure.

Another method that travel suppliers have for distributing information about their products is to maintain a sales and reservation staff who respond to telephone call inquiries. The use of a trained sales and reservation staff, however, is not free of problems. It is expensive to train and maintain a sales and reservation staff. There is often a high degree of personnel turnover among the staff forcing the travel supplier to constantly train new people to sell their travel products. During peak travel booking periods there are often too few sales and reservation personnel available to handle the volume of telephone calls from travel agents. It is not uncommon during these periods for travel agents to be on-hold, waiting for assistance from the sales and reservation staff for up to 30 minutes.

A third method for distributing information that travel suppliers use is facsimiles or emails that are sent to travel agents. For example, a travel agent receives as many as one hundred facsimiles each week. These facsimiles provide detailed information about a particular travel product. Because the information in the facsimiles often refers to special packages that are available for a limited period of time, the facsimiles are highly time-sensitive products. The travel agent must act within a few days of receiving the information in the facsimile, i.e., sell the listed travel product to the client, otherwise the offer for that travel product expires. This problem is further compounded because it is well known in the travel industry that many facsimiles are discarded without ever being read by all travel agents to whom they are sent.

In short, the problem confronting the travel industry is how to effectively distribute time-sensitive information in a way that it can be easily accessed and reviewed by travel agents who are not centrally located. At the present time there is no method or system in the travel industry for solving this information search and distribution problem.

The system and methods of the present invention address this information search and distribution problem for suppliers of travel information by providing (i) the travel agent with a system having a plurality of selection rules that enable the travel agent to rapidly select the best travel product and (ii) the supplier of travel products with a comparatively inexpensive and rapid method for distributing information about all travel products through electronic means. The methods and systems of searching and distributing information using this invention may also be applied to other areas requiring timely distribution of selected information to a geographically disperse group of users.

### SUMMARY OF THE INVENTION

The methods and systems of the invention provide for the search, retrieval and distribution of information to a geographically widely dispersed group of users. Specifically, the method involves searching a database stored on a remotely located computer connected through the Internet to a Web enabled device. The steps comprise: (a) selecting from a plurality of selection criteria a subset of selection criteria; (b) screening the database using the subset of selection criteria for data records satisfying at least one member of the subset of the selection criteria; (c) rank ordering the data records selected in step (b); and (d) displaying the data records that have been rank ordered in step (c) on the Web enabled device.

The database comprises travel related information and the selection criteria may comprise travel related selection criteria.

In one embodiment, there may be least two subsets of selection criteria. Each member of at least one of the subsets of selection criteria may be assigned a numerical weight. The data records in step (c) may be rank ordered by the sum of the numerical weight of the selection criteria used to select the data records. In one embodiment, the data records selected may contain every member of at least one of the subsets of the selection criteria used to select the data records.

The invention also comprises a computer readable storage medium storing a set of instructions, the set of search instructions capable of being executed by a processor to search a database stored on a remotely located computer connected through the Internet to a Web enabled device, the set of instructions performing the steps comprising: (a) selecting from a plurality of selection criteria a subset of selection criteria; (b) screening the database using the subset of selection criteria for data records satisfying at least one member of the subset of the selection criteria; (c) rank ordering the data records selected in step (b); and (d) displaying the data records that have been rank ordered in step (c).

The database may comprise travel related information and the selection criteria travel related selection criteria. The selection criteria may be assigned a numerical weight and this numerical weight may be used to rank order the data records in step (c) by using the sum of the numerical weight for each of the selection criteria used to select the data records.

The invention also comprises a method for distributing at least one virtual faxes over the Internet, comprising the steps of: (a) logging-on from the Web enabled device through a network to a file server that contains a database having a plurality of virtual faxes; (b) selecting at least one selection criteria from a plurality of selection criteria; (c) retrieving from the database all virtual faxes that satisfy the selection criteria used in step (b); and (d) displaying the virtual fax from step (c) on the Web enabled device. As used herein, the term “virtual fax” refers to any information that is stored electronically in any electronic version of the paper facsimile and the term “information” includes advertisements, announcements, surveys, technical information, and the like stored in an audio, video, and/or graphical form digitally. The virtual fax is distributed over the network. The invention also comprises a computer readable storage medium storing a set of instructions, the set of instructions capable of being executed by a processor to direct computers over the Internet, the set of instructions performing the steps comprising:(a) logging-on from the Web enabled device through a network to a file server that contains a database having a plurality of virtual faxes; (b) selecting at least one selection criteria; (c) retrieving from the database all virtual faxes that satisfy the selection criteria used in step (b); and (d) displaying the virtual fax from step (c) on the Web enabled device.

### BRIEF DESCRIPTION OF THE DRAWINGS

FIG. 1 is an illustrative block diagram showing the overall system for providing information to user.

FIGS. 2a and 2b present a block diagram showing the logic flow for the use of the selection criteria.

FIGS. 3a and 3b are block diagrams showing the use of weighting to preferentially search of the database.

FIGS. 4a, 4b and 4c illustrates the application of this search method to travel products.

FIG. 5 is a block diagram showing the virtual fax process flow where there are two databases.

FIG. 6 is a block diagram showing the virtual fax process flow where there is one database.

### DETAILED DESCRIPTION

### Overview of the System

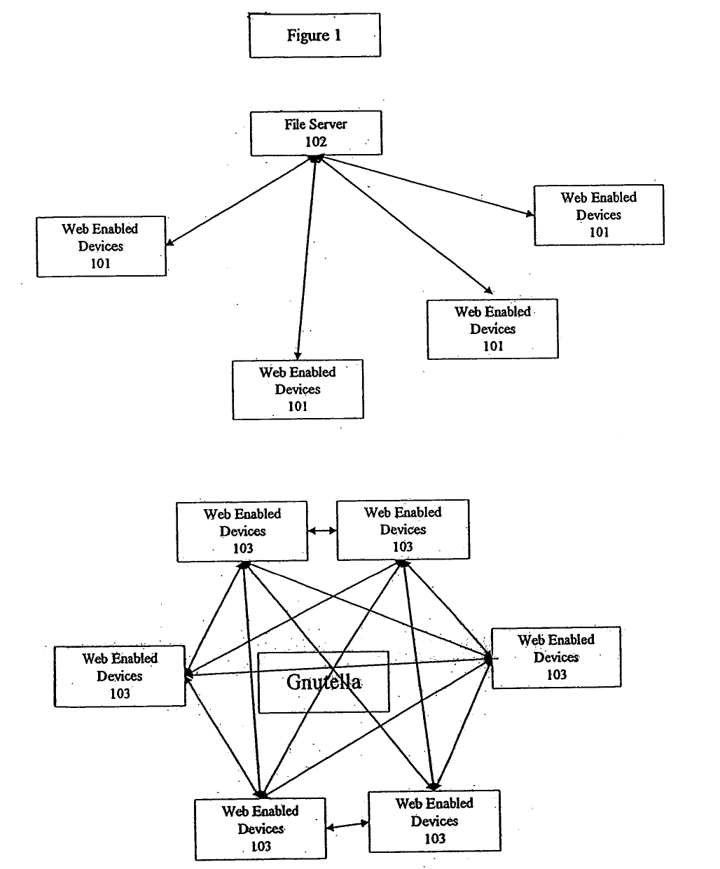

FIG. 1 is an illustrative block diagram showing the overall system for providing information to users. Information can be delivered in response to a user searching a database for information matching the selection criteria entered by that user. Alternatively, information can be delivered by virtual faxes sent to the user.

The network of the present invention can be connected using any standard networking protocol.

As illustrated in FIG. 1, a user logs-on the network through a Web enabled device 101. Web enabled devices comprise computers, personal data assistants or Web enabled telephone. The Web enabled devices are loaded with Internet browsers that are configured to work with any hypertext markup language, including hypertext markup language (HTML), dynamic-HTML (DHTML) or extensible markup language (XML).

The Web enabled devices 101 may be connected to a centrally localized file server 102. In another embodiment, the Web enabled devices may be connected to one another using a fully distributed information-sharing computing network such as Gnutella 103. In response to search queries from the Web enabled device by a user the database on the file server 102 or on the fully distributed information sharing computing network is searched for a data record matching the user's search criteria.

The invention also comprises methods and systems for receiving virtual faxes. For example, when a user logs on from their Web enabled device to the file server 102, the file server 102 sends virtual faxes over the network to the user updating a database of virtual faxes that are maintained locally on the users' Web enabled device 101.

The users' Web enabled device 101 is configured in such a way that information retrieved from a data file can be delivered to the Web enabled device in any multimedia format.

### Remotely Located Computer

The remotely located computer may be a file server 102, which comprises hardware and software for retrieving and organizing a database that contains information. In one embodiment, the database may contain information from travel suppliers about their travel products. The file server can be a Windows NT® file server. In another embodiment, the file server may be UNIX-based. Other operating systems, such as Linnux, NeXtStep®, MacOS and OS/2® can be used interchangeably with Windows NT®.

The software on the file server 102 retrieves information from a database in response to a request for information directed to it from the user's Web enabled device 101.

Any relational data base management system program can be used to retrieve and manage information in the database. Preferably, the relational database management system program uses a Structured Query Language (“SQL”), a fourth generation computer language. The SQL package contains various program tools which may be utilized in the present invention. These tools include: SQL*PLUS, a program for creating, modifying, storing and maintaining the database and SQL*CALC, a program with standard spreadsheet capabilities which can also access and manipulate database information.

In one embodiment, the information stored in the database comprises: (i) technical specifications about a travel product; (ii) price information for the travel product; (iii) comparative pricing information about the travel product, e.g., travel specials; (iv) graphical and pictorial information about the travel product; (v) sales and promotional messages; (vi) a uniform resource locator (URL) address for a Web site containing information and hyperlinks to other Internet Web sites of interest; or (vii) virtual faxes. It will be appreciated that any type of information can be stored and retrieved from the database for transmission over the network.

### Fully Distributed Information Sharing Computing Network

The Web enabled devices may be connected on the Internet through a fully distributed information sharing computing network such as Gnutella. Using a distributed computing system such as Gnutella, the Web-enabled devices 103 act as file servers and search engines on the distributed network sharing files and allowing files on their individual computers to be searched.

### Search Selection Methods and Systems

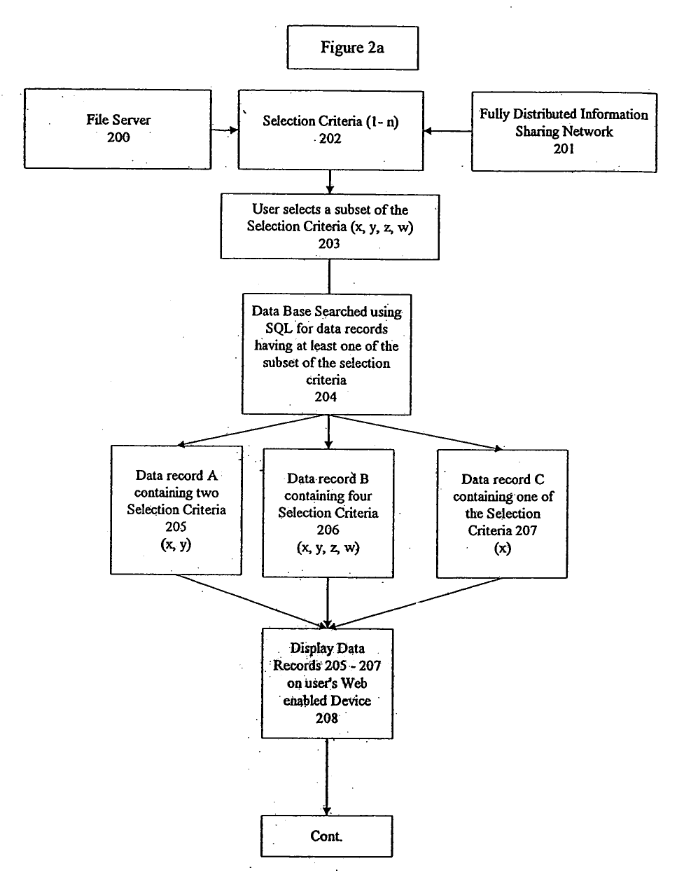

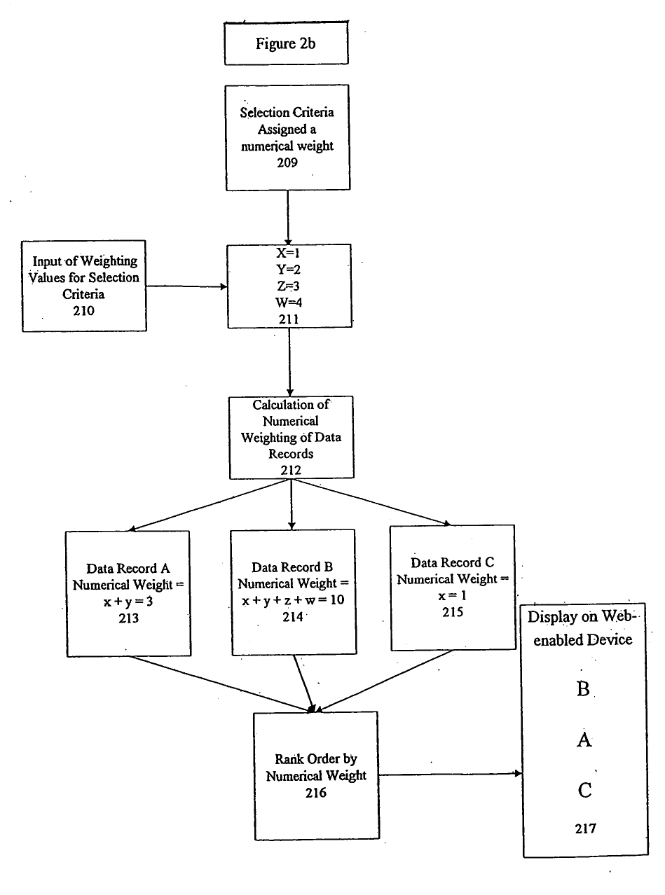

After logging-on the network either to the file server 200 or on the fully distributed information computer sharing network 201, the user is presented with a set of selection criteria. FIGS. 2a and 2b present a block diagram showing the flow for the selection criteria. A plurality of different selection criteria are presented for selection by the user 202. The user selects a subset of the selection criteria 203 and uses this subset to search the database 204 using an SQL query to select those data records that satisfy at least one subset of the search criteria selected by the user 204. The SQL query of the invention may be set to select data records satisfying as few as one of the selection criteria, or as many as all of the selection criteria. An example of data records selected that contain at least one member of the subset of the selection criteria 204 is show in FIG. 2: data record A, selection criteria x,y (205), data record B, selection criteria x, y, z and w (206) and data record C, selection criteria x (207). The results of the search may be displayed on the user's Web enabled device 208 or processed further.

The data records selected may be rank-ordered as follows. The software of the invention allows assignment of a numerical weight factor to each selection criteria. 209. These numerical weight values may be assigned by the user and input into the software algorithm of the invention 210. For example, the selection criteria x, y, z and w may be assigned numerical weights of 1, 2, 3 and 4, respectively 211, out of a scale of 1-10. The software algorithm calculates a numerical weight for each of the data records 212 by summing the numerical weights for each selection criteria present in each of the data record. Thus, in the example shown, the numerical weights for the data records A, B and C are 3, 10 and 1 respectively, 213, 214, and 215. The data records are then rank ordered by numerical weight 216 and displayed on the Web enabled device to the user 217. As will be appreciated, any numerical weighting may be applied to a particular selection criteria in order to preferentially rank order those data records containing that particular selection criteria.

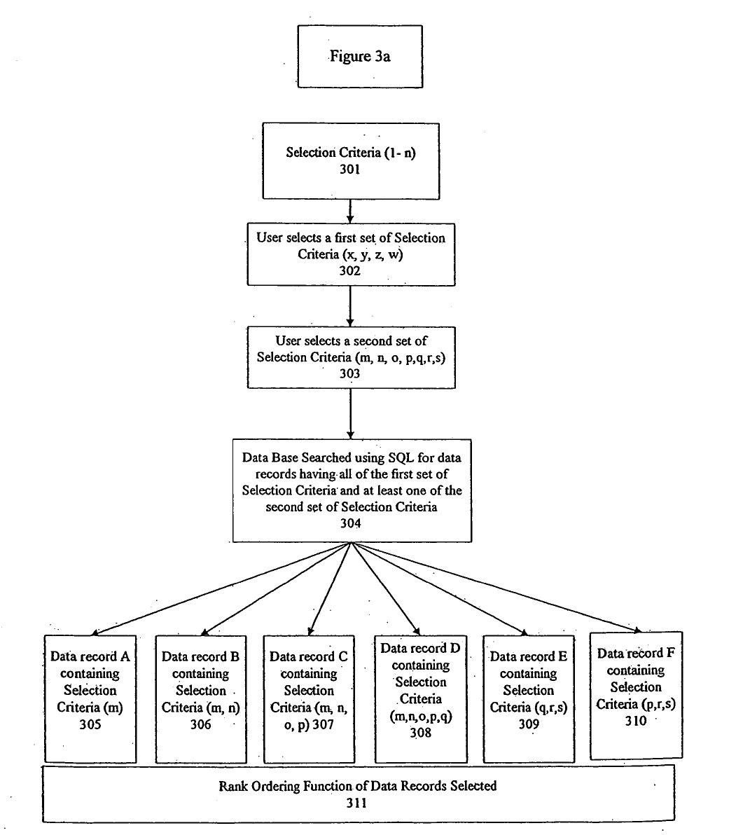

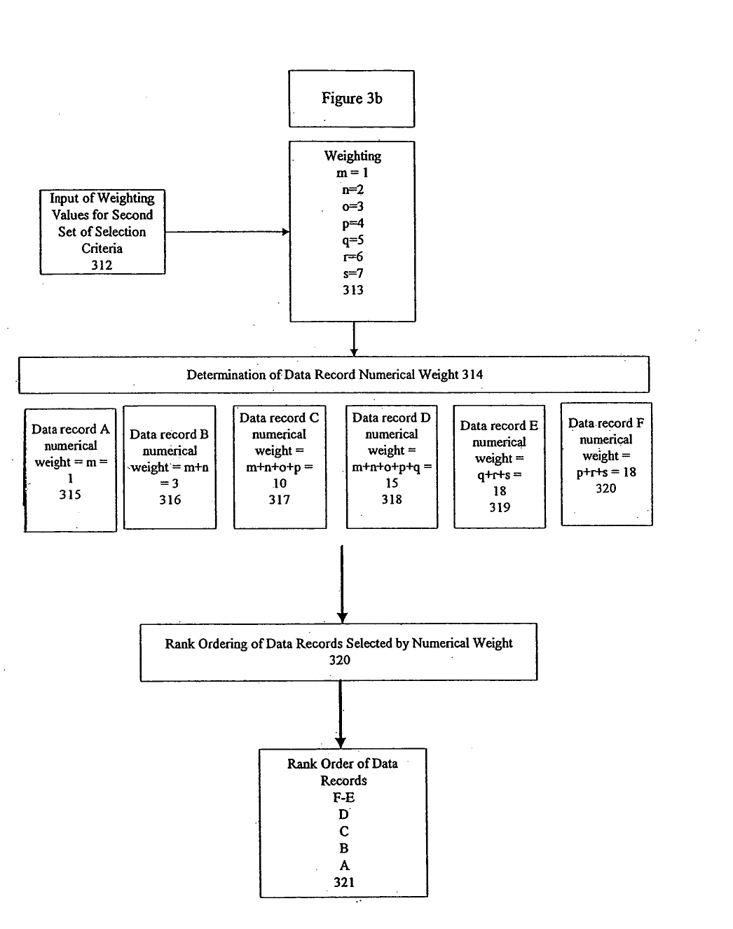

FIGS. 3a and 3b are block diagrams showing the use of weighting to preferentially search the database. The user is presented with selection criteria 1−n. The user selects a first set of selection criteria, represented as x, y, z and w. 302. The user then selects a second set of selection criteria, represented as m, n, o, p, q, r and s. 303. The data base is then searched using an SQL query for data records having all of the first set of selection criteria (x, y, z) and at least one of the second set of selection criteria (m, n, o, p, q, r and s). 304.

A sample of data records satisfying the above criteria is shown in FIG. 3a as 305-310. Specifically, data record A (m) 305, data record B (m, n) 306, data record C (m, n, o, p) 307, data record D (m, n, o, p, q) 308, data record E (q, r, s) 309 and data record F (p, r, s) 310. The software algorithm of the invention then allows rank ordering of the data records selected. 311. For example, the weighting values for the second set of selection criteria 312 may be m=1, n=2, o=3, p=4, q=5, r=6, s=7. 313. (for illustration purposes only, the scale is 1-10 for this set of numerical weightings). It will, however, be appreciated that any numerical weightings may be assigned. In addition, numerical weightings may be assigned to the first set of selection criteria.

The software algorithm of the invention then determines the numerical weighting for each data record. 314. The numerical weights for the sample data are shown in FIG. 3b as: data record A=1, 315, data record B=3, 316, data record C=10, 317, data record D=15, 318, data record E=18, 319, and data record F, 18, 320. The data records are then rank ordered based on the numerical weightings. 320. The rank order for the selected data records is shown in descending order as F-E, D, C, B, and A. 321. The rank ordered data may then be distributed over the network to the Web enabled devices.

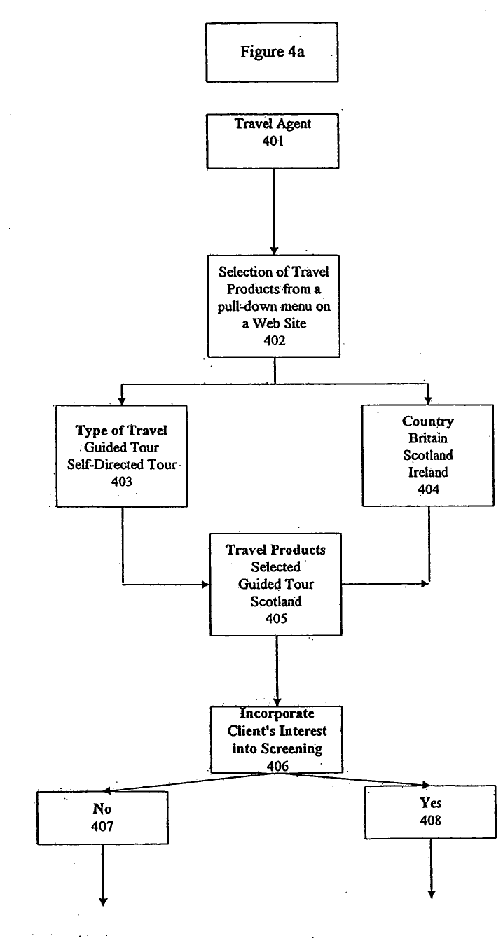

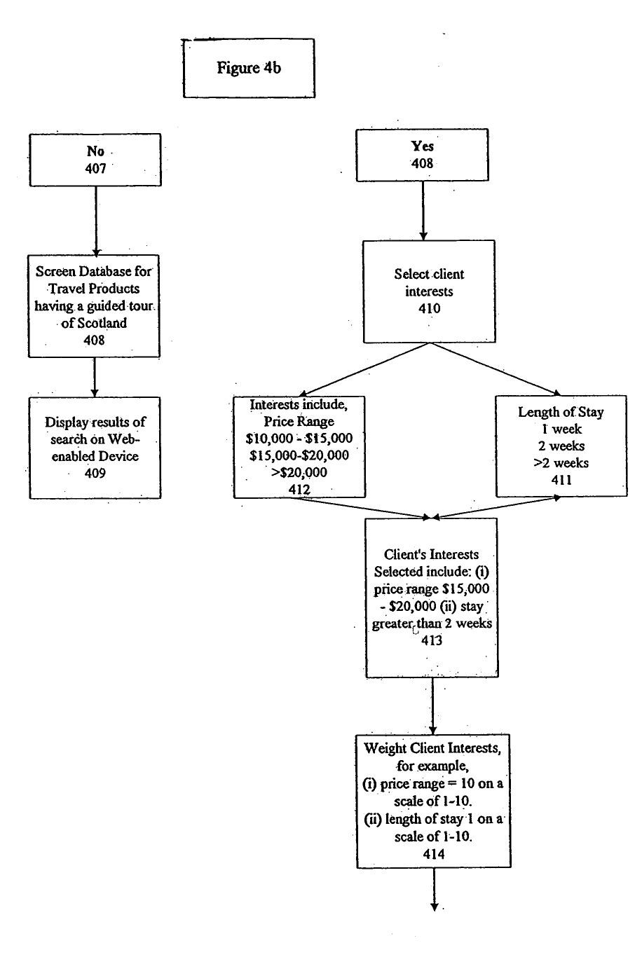

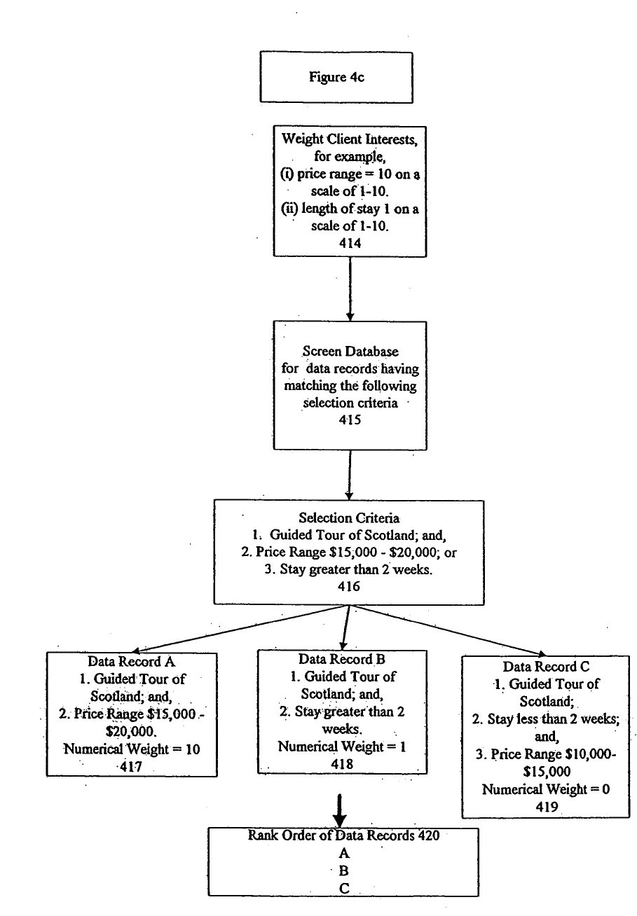

FIGS. 4a, 4b and 4c illustrates the application of this search method to travel products. A travel agent 401 selects a variety of different travel products from a pull-down menu presented on a Web site. 402. For example, the travel products may comprise (i) type of travel 403 and (ii) country (destination) 404. In the example shown, the travel agent could select a guided tour of Scotland. 405. The travel agent would then be asked whether they wish to incorporate selection criteria regarding a client's interests. 406. If the travel agent selects “No” 407, the database is screened for travel products showing a guided tour of Scotland 408 and the results displayed on the Web enabled device. 409. Alternatively, if the travel agent elects to incorporate a client's interests into the selection program 408, the travel agent is directed to select client interests. 410. For example, the client interests could include (i) price range 412 and (ii) length of stay 411. Based on discussions with the client, the following interests could be selected (i) price range $15,000-$20,000 and (ii) stay greater than 2 weeks. 413. The relative importance of these client interests may be rank ordered as shown where the price range is given a score of 10 on a scale of 1 to 10 whereas the length of stay is give a score of 1 on the same scale. 414. The database is then screened for data records matching the following criteria 415 (i) guided tour of Scotland and (ii) price range $15,000-$20,000 or (iii) a stay greater than 2 weeks. 416. As will be appreciated any combination of different selection criteria and/or weighting factors may be used to screen the data base. The data base is then screened using an SQL query and, in the example shown, three data records are selected. The data records selected have the following data characteristics: (i) data record A (guided tour of Scotland, price range $15,000-$20,000), numerical weight 10, 417, data record B (guided tour of Scotland, stay greater than 2 weeks), numerical weight 1, 418, and data record C (guided tour of Scotland, stay less than 2 weeks, and price range $10,000-$15,000), numerical weight 0, 419. The data records are then rank ordered as follows in descending numerical order A, B, and C 420 and displayed on the Web enabled device of the travel agent.

As will be appreciated, the search criteria and the weighting factors may be freely altered in order to target particular types of data records.

### Virtual Fax System

After logging on the network, the user may elect to access the virtual fax system. The virtual fax contains information allowing targeting of the virtual fax to specific users. The information represented by the virtual fax may be maintained centrally on a file server or locally on a user's Web enabled device. Information may be added to the database by any user, including the user to whom virtual faxes are directed.

### Virtual Fax Table

The following example describes the application of the methods and systems of the invention to travel related products. This particular embodiment is shown having two databases, one maintained locally on the user's Web enabled device and other centrally on a file server. In another embodiment, one database may be maintained on the file server that is accessed over a network through the user's Web enabled device.

The database table containing virtual fax information includes: a code used to identify the virtual fax, the virtual fax's effective and expiration dates and the HTML needed to build the virtual fax. The virtual fax can be “prebuilt” by supplying either a preexisting HTML or XML file or an image file. The FaxCode represents the primary sort key for this table.

TABLE I
Virtual Fax Table

| Layout | | |
|---|---|---|
| Field | Type of Data | Record Length |
| FaxCode | Text | 10 |
| OperatorCode | Text | 5 |
| EffectiveDate | Date/Time | 8 |
| ExpirationDate | Date/Time | 8 |
| FaxHTML | Memo | — |
| FaxFileName | Text | 30 |

### Virtual Fax Distribution Table

Description

For each virtual fax, the type of distribution and the specific identifier for the destination may be specified. Virtual faxes may be targeted to individual travel agencies or to a group of travel agencies using any combination of selection criteria. For example, selection criteria may include, all travel agents within a particular geographical area, specific travel agents within a specific travel agency, or all travel agencies that service a particular type of consumer, e.g., persons over 60. In this case, the selection criteria are set by the supplier of travel products that may, for example, desire to target a particular group of travel agents. Alternatively, virtual faxes may be retrieved by travel agents who request a specific virtual fax or specific group of virtual faxes using an SQL sort query to select virtual faxes satisfying selection criteria, e.g., travel products provided by one type of company.

Table II illustrates the primary sorting keys that may be used for the virtual fax distribution by the invention.

TABLE II
Virtual Fax Distribution Table

| Layout | | |
|---|---|---|
| Field | Type of Data | Record Length |
| FaxCode | Text | 10 |
| DistributionType | Text | 5 |
| DistributionCode | Text | 10 |

### Virtual Fax Index Table

Description

This table contains the information used to cross reference a virtual fax with various search attributes. This information is used by travel agents to search for virtual faxes satisfying particular selection criteria.

Each virtual fax has one summary indicator record and multiple “index” rows. The summary row is used to limit the number of rows returned when displaying results from a search. The primary sort keys for this table include: FaxCode, OperatorCode, DestinationAreaCode, Activity, Low Price (LoPrice), HighPrice, Duration and Special Summary (SummaryInd).

TABLE III
Virtual Fax Index Table

| Layout | | |
|---|---|---|
| Field | Type of Data | Record Length |
| FaxCode | Text | 10 |
| OperatorCode | Text | 5 |
| DestinationAreaCode | Text | 5 |
| Activity | Text | 50 |
| LoPrice | Number (Long) | 4 |
| HighPrice | Number (Long) | 4 |
| Duration | Text | 30 |
| SummaryInd | Yes/No | 1 |
| EffectiveDate | Date/Time | 8 |
| Gen_SpecialDetail | Number (Long) | 4 |
| ExpirationDate | Date/Time | 8 |
| SpecialPrice | Text | 50 |
| SpecialDetail | Memo | — |
| SpecialSummary | Memo | — |
| Picture1 | Text | 30 |
| Picture2 | Text | 30 |
| Picture3 | Text | 30 |
| Picture4 | Text | 30 |
| Picture5 | Text | 30 |
| Template | Number (Integer) | 2 |
| TourCode | Text | 15 |
| DateText | Text | 50 |
| Jan | Yes/No | 1 |
| Feb | Yes/No | 1 |
| Mar | Yes/No | 1 |
| Apr | Yes/No | 1 |
| May | Yes/No | 1 |
| Jun | Yes/No | 1 |
| Jul | Yes/No | 1 |
| Aug | Yes/No | 1 |
| Sep | Yes/No | 1 |
| Oct | Yes/No | 1 |
| Nov | Yes/No | 1 |
| Dec | Yes/No | 1 |
| PriceRange | Number (Integer) | 2 |
| Desc1 | Memo | — |
| Desc2 | Memo | — |
| Desc3 | Memo | — |
| Desc4 | Memo | — |
| Desc5 | Memo | — |
| HTMLPage | Text | 50 |
| HTMLPicture | Text | 50 |
| DateUpdated | | |

### Virtual Fax Process Flow

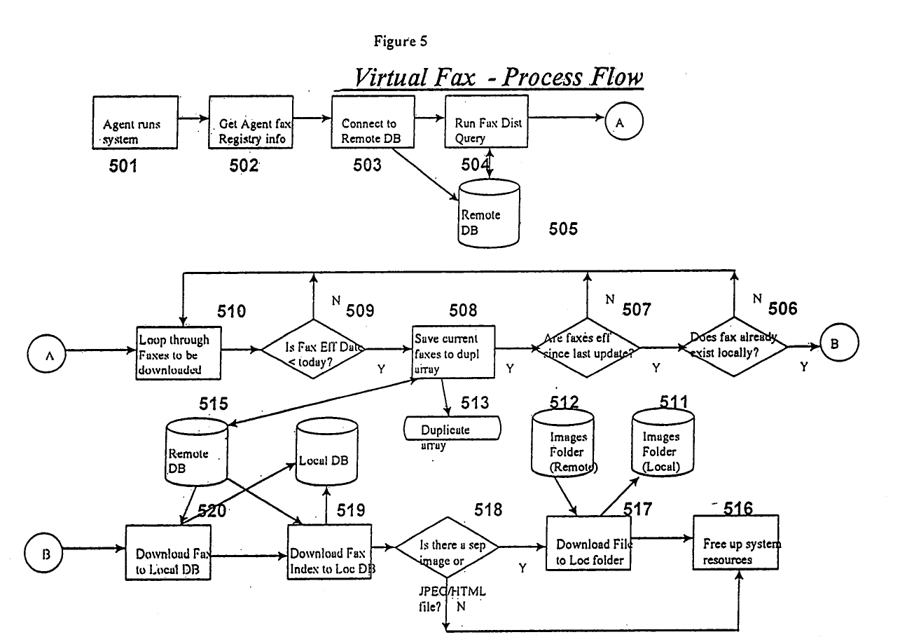

FIG. 5 is a block diagram showing the virtual fax process flow where there are two databases. The travel agent logs on the network through the Web enabled device. Once the travel agent is logged on the network and connected to the database 503 the travel agent runs the virtual fax software program of the invention. The software program retrieves the virtual fax registry information 502 from the database on the database server 505 to determine whether there are virtual faxes present in the database that are marked for distribution to the travel agent.

Next, using the virtual fax registry 502, the software program of the invention then compares the virtual faxes residing on the database-on the Web enabled device with those virtual faxes present in the virtual fax registry 502 to determine whether those virtual faxes found in the database on the database exist locally 505 on the Web enabled device. Next, the software program of the invention determines whether the virtual faxes residing on the database in the Web enabled device are effective 507. To determine whether the virtual faxes are effective, the software program compares the date on which the travel agent logs on the database of the server with the effective data specified in the virtual fax data set and deletes those virtual faxes from the local database on the Web enabled device that have expired, i.e., where the date of log-on is after the expiration date listed on that virtual fax. The software program also generates a duplicate array of virtual faxes in the database on the Web enabled device database, for subsequent comparison of the virtual faxes in the database server with those in the Web enabled device 508 to prevent download of duplicate virtual faxes during the next log-in by the travel agent.

In one embodiment, only an index of the virtual faxes received is maintained on the database on the Web enabled device.

The software system then checks the database on the database of the file server for virtual faxes that are targeted for distribution to that travel agent. As noted above, each virtual fax contains information directing the distribution of the virtual fax. Those virtual faxes marked for down-load to a particular travel agent are-selected and retrieved from the database on the file server for down-loading over the network to the database on the Web enabled device. Before down-loading any virtual faxes to the Web enabled device, the software program determines whether the effective date of the virtual fax to be down-loaded is earlier or later than the date that the travel agent's logs on the network 509. If the effective date is earlier than the log-on, the virtual fax is not down-loaded and the system resets to examine the next virtual fax for possible down-load. Alternatively, if the effective date of the virtual fax to be down-loaded is later than the date of the travel agent's log-on, the virtual fax is down-loaded to the Web enabled device's database. 510, 519, 520.

Once the virtual faxes are downloaded, the virtual faxes are presented to the travel agent as a list on a Web page hyperlinked to the information contained within each virtual fax. This information may be accessed by clicking on the particular fax or each virtual fax shown in the table by clicking with the mouse on the icon of a particular virtual fax and displaying the information on the Web enabled device.

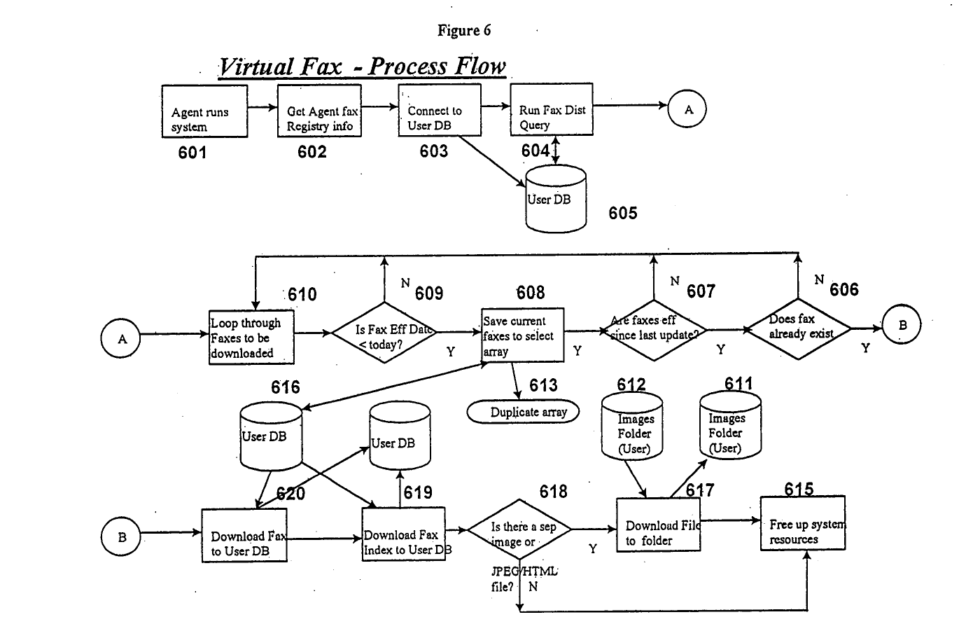

FIG. 6 is a block diagram showing the virtual fax process flow where there is one database, a user database, that may be maintained on the file server. The virtual fax process flow is identical to the process shown in FIG. 5, except that there is one database, the user database 605. The user may query the user database 605 using an SQL query to select virtual faxes satisfying any selection criteria that the user enters into the SQL request.

The methods and systems of distributing information of this invention may also be applied to other types of information retrieval and distribution systems requiring timely presentation of multimedia information to a geographically disperse group of users.

1. A method for searching a database stored on a remotely located computer connected through the Internet to a Web enabled device, comprising the steps of:
(a) selecting from a plurality of selection criteria at least one subset of selection criteria;
(b) screening and selecting from the database using the subset of selection criteria for data records satisfying at least one member of the subset of the selection criteria;
(c) rank ordering the data records selected in step (b); and
(d) displaying the data records that have been rank ordered in step (c).

2. The method of claim 1, wherein the database comprises travel related information.

3. The method of claim 2, wherein the selection criteria comprise travel related selection criteria.

4. The method of claim 1, wherein at least two subsets of selection criteria are used in step (b).

5. The method of claim 4, wherein each member of at least one of the subsets of the selection criteria is assigned a numerical weight.

6. The method of claim 4, wherein the data records in step (c) are rank ordered by the sum of the numerical weights of the selection criteria used to select the data records in step (b).

7. The method of claim 4, wherein the data records selected contain every member of at least one of the subsets of the selection criteria used in step (b).

8. A computer readable storage medium storing a set of instructions, the set of instructions capable of being executed by a processor to search a database stored on a remotely located computer connected through the Internet to a Web enabled device, the set of instructions performing the steps comprising:
(a) selecting from a plurality of selection criteria at least one subset of selection criteria;
(b) screening the database using the subset of selection criteria for data records satisfying at least one member of the subset of the selection criteria;
(c) rank ordering the data records selected in step (b); and
(d) displaying the data records that have been rank ordered in step (c).

9. The computer readable storage medium of claim 8, wherein the database comprises travel related information.

10. The computer readable storage medium of claim 9, wherein the selection criteria comprise travel related selection criteria.

11. The computer readable storage medium of claim 8, wherein at least two subsets of selection criteria are used in step (b).

12. The computer readable storage medium of claim 11, wherein each member of at least one of the subsets of the selection criteria is assigned a numerical weight.

13. The computer readable storage medium of claim 12, wherein the data records selected in step (c) are rank ordered by the sum of the numerical weight of the selection criteria used to select the data records.

14. The computer readable storage medium of claim 11, wherein the data records selected in step (c) contain every member of at least one of the subsets of selection criteria used in step (b).

15. A method for distributing at least one virtual fax over the Internet to a plurality of Web enabled devices, comprising the steps of:
(a) logging-on from the Web enabled device through a network to a file server that contains a database storing a plurality of virtual faxes;
(b) selecting at least one selection criteria from a plurality of selection criteria;
(c) retrieving from the database all virtual faxes that satisfy the selection criteria used in step (b); and
(d) displaying the virtual fax from step (c) on the Web enabled device.

16. The method of claim 15, wherein the selection criteria comprise virtual faxes that have not been previously displayed and retrieved.

17. The method of claim 15, wherein the database comprises information about travel products.

18. The method of claim 17, wherein the selection criteria comprise a plurality of targeting criteria used to direct the virtual fax to a particular group of users.

19. A computer readable storage medium storing a set of search instructions, the set of instructions capable of being executed by a processor to direct Web enabled devices linked over the Internet, the set of instructions performing the steps of:
(a) logging-on from the Web enabled device through a network to a file server that contains a database storing a plurality of virtual faxes;
(b) selecting at least one selection criteria from a plurality of selection criteria;
(c) retrieving from the database all virtual faxes that satisfy the selection criteria in step (b); and
(d) displaying the virtual fax from step (c) on the Web enabled device.
